(19) United States
(12) Patent Application Publication
(10) Pub. No.: US 2018/0128454 A1
(43) Pub. Date: May 10, 2018

(54) VARIABLE SHUTTERS ON AN ENERGY SOURCE

(71) Applicant: Hewlett-Packard Development Company, L.P., Houston, TX (US)

(72) Inventors: Matthew A Shepherd, Vancouver, WA (US); Wesley R Schalk, Camas, WA (US); Pierre J Kaiser, Portland, WA (US); Arthur H. Barnes, Vancouver, WA (US); Matt G Driggers, Vancouver, WA (US)

(21) Appl. No.: 15/568,976

(22) PCT Filed: Jul. 29, 2015
(86) PCT No.: PCT/US2015/042685

§ 371 Date: Oct. 24, 2017

(51) Int. Cl. F21V 14/08; H05B 1/02; H05B 41/38

(52) U.S. Cl. CPC F21V 14/08; H05B 41/38; H05B 1/023

(57) ABSTRACT

In example implementations, an apparatus and method are provided. The apparatus includes a movable carriage, an energy source coupled to the movable carriage and a plurality of shutters coupled to the movable carriage. In one example, the plurality of shutters is coupled to the movable carriage along a length of the energy source. Each one of the plurality of shutters may be coupled to the movable carriage via respective coupling mechanism that provides a continuously variable movement of each one of the plurality of shutters.

### BACKGROUND

Energy sources may be used for a variety of different applications. Some applications may use a lamp or light source as the energy source. For some applications the lamp or light source is fixed. The lamp controls an amount of heat by turning on or off.

### BRIEF DESCRIPTION OF THE DRAWINGS

FIG. 1 is a block diagram of an example apparatus of the present disclosure;

FIG. 2 is a detailed block diagram of an example of the heat carriage with a plurality of shutters of the present disclosure;

FIG. 3 is a cross sectional view of an example illustration of a continuously variable movement of a shutter;

FIG. 4A is a block diagram of an example coupling mechanisms;

FIG. 4B is a block diagram of an example coupling mechanism;

FIG. 4C is a block diagram of an example shutter design;

FIG. 4D is a block diagram of an example shutter design; and

FIG. 5 is a flowchart of an example of a method for controlling the heat carriage and the plurality of shutters.

### DETAILED DESCRIPTION

The present disclosure discloses an apparatus and method for controlling the movable carriage having an energy source and a plurality of shutters. As discussed above, energy sources may be used for a variety of different applications. Some applications may use a lamp or light source as the energy source. For some applications the lamp or light source is fixed. The lamp controls an amount of heat by turning on or off. Flickering caused by the lamp turning on and off can have side effects.

In addition, the lamp may have an uneven energy profile along a length of the bulb. For example, the ends may be cooler than the middle. Thus, some devices use a lamp that is larger than a target area to compensate for the difference in the heating profile along the length of the bulb. This can lead to devices that have a larger footprint.

Examples of the present disclosure provide a method for controlling a movable carriage having an energy source and a plurality of shutters coupled to the movable carriage. The shutters can be controlled in a continuously variable manner that allows the shutters to be positioned to a full open, a full closed or any position between the full open and the full closed position. The combination of the movable carriage and the plurality of shutters provide the ability to control an amount of heat or energy applied to any coordinate on a two dimensional powder bed.

The movable carriage with the energy source and the plurality of shutters may provide finer granularity control of the amount of heat or energy applied to any area of the powder bed. In addition, the frequency of the plurality of shutters can be faster than modulating a lamp on and off.

Furthermore, the energy source may be closer to the width of the powder bed. In other words, the energy profile along a length of the energy source can be evened out by the use of the plurality of shutters. As a result, the overall size and costs associated with the movable carriage can be reduced.

Additional cost savings may be realized by using lower costs lamps. For example, a commodity type lamp (e.g., a halogen lamp) may be used with the plurality of shutters and movable carriage to achieve an equivalent energy control of expensive high response lamps (e.g., lamps that can be turned on and off in milliseconds).

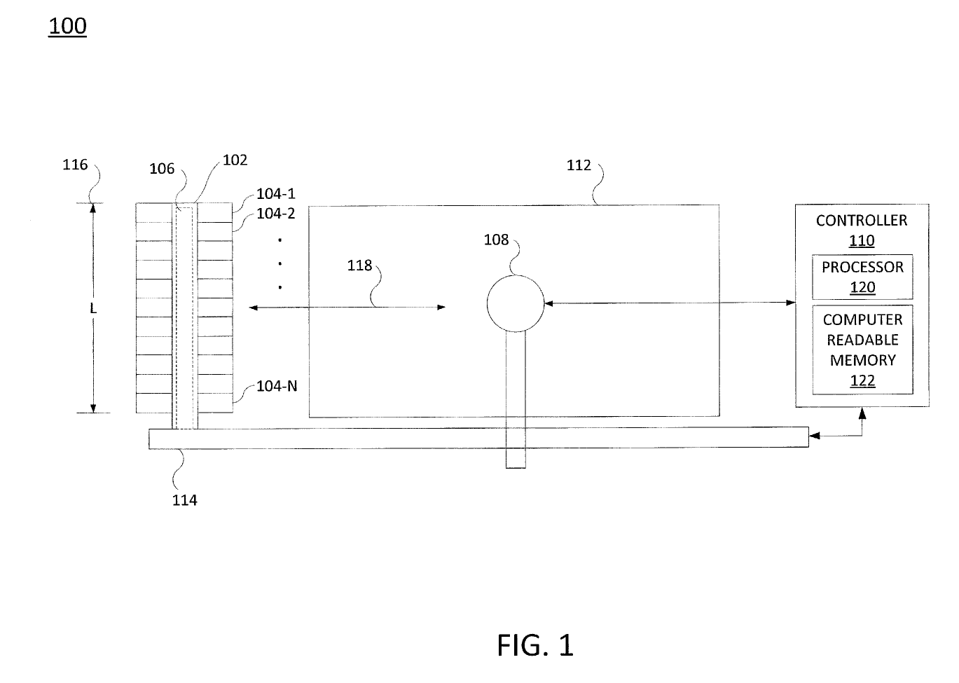

FIG. 1 illustrates an example top view of an apparatus 100 of the present disclosure. In some examples, the apparatus 100 may include a movable carriage 102 coupled to a rail 114, a thermal camera 108, a controller 110 and a powder bed 112. The movable carriage 102 may include an energy source 106 (shown in dashed lines below the movable carriage 102) and a plurality of shutters 104-1 to 104-N (also referred to herein individually as a shutter 104 or collectively as shutters 104).

In one example, the rail 114 may comprise a plurality of guiding surfaces, tracks, or rails. For example, the movable carriage 102 may be supported by multiple parallel rails 114. Thus, although a single rail 114 is illustrated in FIG. 1 it should be noted that the rail 114 may comprise multiple rails.

In one example, the apparatus 100 may be a three dimensional (3D) printing system. For example, any type of material used to print a 3D part or item may be placed on the powder bed 112. The movable carriage 102 with the energy source 106 may be moved along a scan direction 118 over the powder bed 112 to heat the materials on the powder bed 112. The scan direction 118 may be in a direction across the powder bed 112.

In some examples, the energy source 106 may be any type of energy source that emits a light, a radiation, a photon, and the like that can be used to heat or energize the materials on the powder bed 112. In one example, the type of energy source 106 may be a function of the type of material that is being heated or energized. In another example, the energy source 106 may be a halogen lamp. The energy source 100 may provide enough energy or heat to melt or sinter the material to be shaped and molded into the desired 3D part or item. Although a single tubular energy source 106 is illustrated in FIG. 1, the energy source 106 may include an array of energy sources 106 arranged along the length 116 (e.g., an array of circular lamps or bulbs arranged in an array).

In one example, the thermal camera 108 may be used to measure an amount of heat in each coordinate of the powder bed 112. The analysis of the heat may be fed to a controller 110. The controller 110 may then control the movable carriage 102 with the energy source 106 and each one of the plurality of shutters 104 along a length 116 of the energy source 106 to apply an appropriate amount of heat to each coordinate of the powder bed 112. In addition, the controller 110 may control the amount of heat to be applied by controlling whether the energy source 106 is turned on, turned off or dimmed to any level of energy output between on and off.

The movable carriage 102 may travel along the scan direction 118 via the rail 114. In combination with the plurality of shutters 104 along a length of the energy source 106, the controller 110 may have the ability to apply an appropriate amount of energy or heat to any coordinate of the powder bed 112.

In one implementation, the controller 110 may include a processor 120 and a computer readable memory 122. In one example, the processor 120 may be a single processor or may include multiple hardware processor elements. In one example, the computer readable memory 122 may include non-transitory computer readable storage mediums such as hard disk drive, a random access memory, and the like.

The computer readable memory 122 may store various parameters and instructions used to analyze the data received from the thermal camera 108, control the movable carriage 102 (e.g., speed and direction), control the energy source 106 and control the shutters 104. In one example, the computer readable memory 122 may include instructions that are executed by the processor 120 of the controller 110 to cause examples described herein to perform an operation or operations and/or processes as described herein.

In some examples, the shutters 104 may be individually coupled to the movable carriage 102 via a coupling mechanism that allows for continuously variable movement. Continuously variable movement may be defined as allowing a shutter 104 to move between any positions from allowing 100% of energy emitted by the energy source 106 to pass through to 0% of the energy emitted by the energy source 106 to pass through. To illustrate, the coupling mechanism may allow the shutter 104 to move from a full open position (e.g., 100% of the energy emitted by the energy source 106 may pass through) to a slightly less open position (e.g., 99% of the energy emitted by the energy source 106 may pass through) to an even less open position (e.g., 98% of the energy emitted by the energy source 106 may pass through), and so forth incrementally, to a full closed position (e.g., 0% of the energy emitted by the energy source 106 may pass through). It should be noted that although the example above uses whole integer increments, the shutter may be closed incrementally in fractional or non-integer percentages (e.g., 100%, 99.99%, 99.98%, or 100%, 99.9%, 99.8%, and so forth).

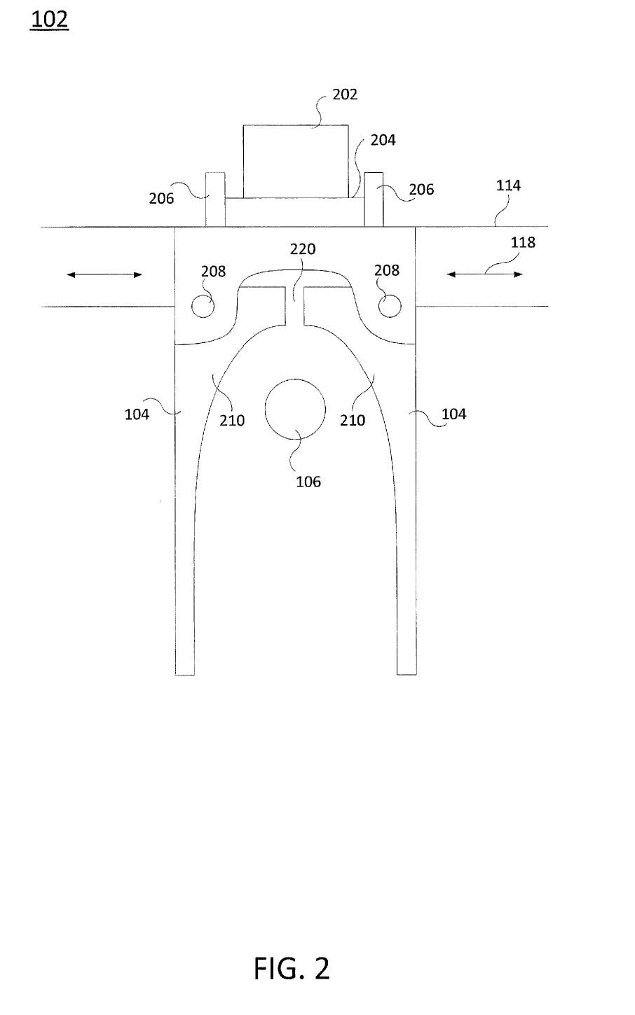

FIG. 2 illustrates an example cross sectional view of a detailed block diagram of a shutter 104. FIG. 2 illustrates the shutter 104 and the movement of the energy source 106 on the movable carriage 102 along a scan direction 118 via the rail 114.

In one implementation, each shutter 104 may comprise opposing members or paddles that have an inner surface 210. In some examples, the inner surface 210 may be any type of reflective material that prevents the shutter 104 from absorbing the energy emitted from the energy source 106 and heating the materials on the powder bed 112. In some examples, the inner surface 210 may be a polished aluminum, a gold plating, a silver plating, and the like.

In one example, the inner surface 210 may have a curved or conic cross section to redirect the energy emitted by the energy source 106 directly onto an area below the energy source 106 on the powder bed 112. In other words, the shape of the inner surface 210 collimates the energy emitted from the energy source 106 so that the energy is focused directly below the energy source 106. Said another way, the inner surface 210 may be shaped to minimize the amount of energy that bleeds outside of a target area of the energy source to heat unintended areas on the powder bed 112 or other parts of the apparatus 100 (e.g., the rail 114, the thermal camera 108, and the like).

In one implementation, the opposing members or paddles create an opening 220 at a top of the shutter 104. As a result, during a full closed position, the heat generated by the energy source 106 may be reflected by the inner surface 210 and redirected upwards and away from the powder bed 112. In other words, the opening 220 may provide a chimney effect.

Although the shutter 104 is illustrated as being two separate opposing members, it should be noted that the shutter 104 may be a single piece. The coupling mechanisms described herein may be modified to attach a shutter 104 comprising a single piece that allows the shutter 104 to move in such a way to allow all, none or any amount in between of the energy emitted by the energy source 106 to pass through to the materials on the powder bed 112.

In one example, each shutter 104 may include an extending member 206 and pivot points 208. In one example, each shutter 104 may be coupled to the movable carriage 102 via a servo motor 202 and a cam 204. The extending members 206 of the shutter 104 may be in contact with the cam 204. The servo motor 202 may be powered to rotate causing the cam 204 to also rotate. The rotation of the cam 204 may move the shutter 104 between an open position, closed position and any position in between. Although FIG. 2 illustrates the use of a servo motor 202, it should be noted that any motorized means, or gear mechanism, to actuate, or move, the cam 204 may be used.

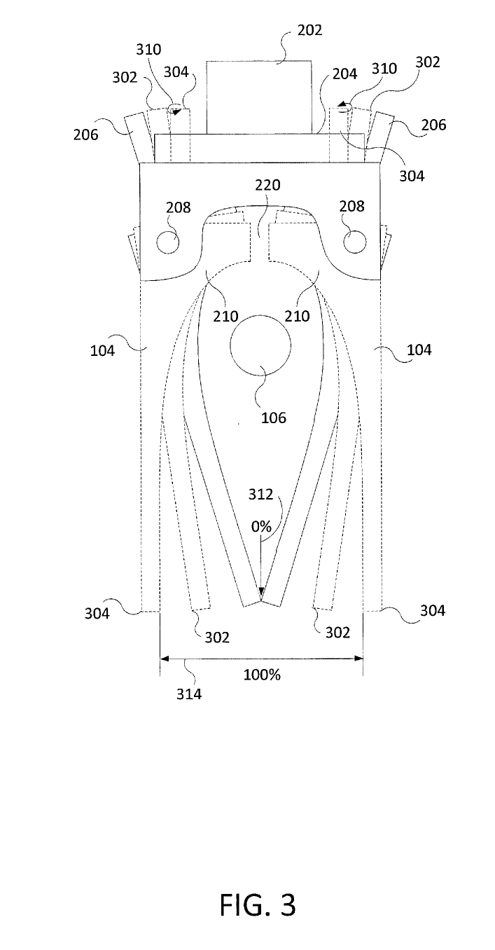

FIG. 3 illustrates an example of a cross sectional view of an example illustration of the continuously variable movement of the shutter 104. In one example, when the tips of the shutter 104 come together the shutter 104 may be closed or allow 0% of the energy emitted by the energy source 106 to be emitted as shown by line 312.

In some examples, the cam 204 may have an elliptical shape, an oblong shape, a spiral shape, a double spiral shape or any other geometric shape in order to function with the servo motor 202 to move the shutter 104 into an open or a closed position. In the closed position, the widest portion of the cam 204 is in contact with the extending members 206. As a result, the extending members 206 are pushed outwards causing the tips of the shutter 104 to come together.

As the servo motor 202 rotates, illustrated by arrows 310, the cam 204 is also rotated such that the narrowest portion of the cam 204 is in contact with the extending members 206. As a result, the extending members 206 are pushed inwards, pivoting around the pivot points 208, to allow the tips of the shutter 104 to be spread open to full open position or allow 100% of the energy emitted by the energy source 106 to be emitted as shown by line 314.

In one example, the extending members 206 may be spring loaded. As a result, when the narrowest portion of the cam 204 is in contact with the extending members 206, the spring may retract to a neutral position, thereby, pulling the extending members 206 to a default position that corresponds to the full open position.

As the servo motor 202 rotates and the cam 204 transitions from a widest portion, to a less wide portion to the narrowest portion, the tips of the shutter 104 may gradually open. This is illustrated by corresponding dashed lines 302 and 304 show a silhouette of the shutter 104 going from a closed positioned, to a slightly open position (dashed lines 302) to a full open position (dashed lines 304).

In addition, as discussed above, the opening 220 may provide a chimney effect for the heat generated by the energy source 106. For example, in the closed position, the width of the opening 220 may be widest to allow a maximum amount of heat reflected by the inner surface 210 to escape up and away from the powder bed 112. In a full open position, the width of the opening 220 may be the narrowest to allow the heat generated by the energy source 106 to be directed downward to heat the materials on the powder bed 112.

In one example, the full open position may not be the same width for each shutter 104. In other words, the width of the line 314 corresponding to the full open position may be different for two or more of the shutters 104-1 to 104-N along a length of the energy source 106.

As discussed above, the energy source 106 may have an uneven energy profile along the length 116 of the energy source 106. For example, the center of the energy source 106 may emit the highest amount of energy and the ends of the energy source 106 may emit the lowest amount of energy. To provide a more even energy profile, the center most shutter 104 may have the narrowest full open position and the width of the adjacent shutters 104 may be slightly wider in the full open position. The width of the full open position of each subsequent adjacent shutter 104 may continue to be gradually wider until the shutters 104 at the ends of the energy source 106 are reached. The shutters 104 at the ends of the energy source 106 may have the widest opening in the full open position. In another example, each one of the shutters 104 may have a same width at a full open position.

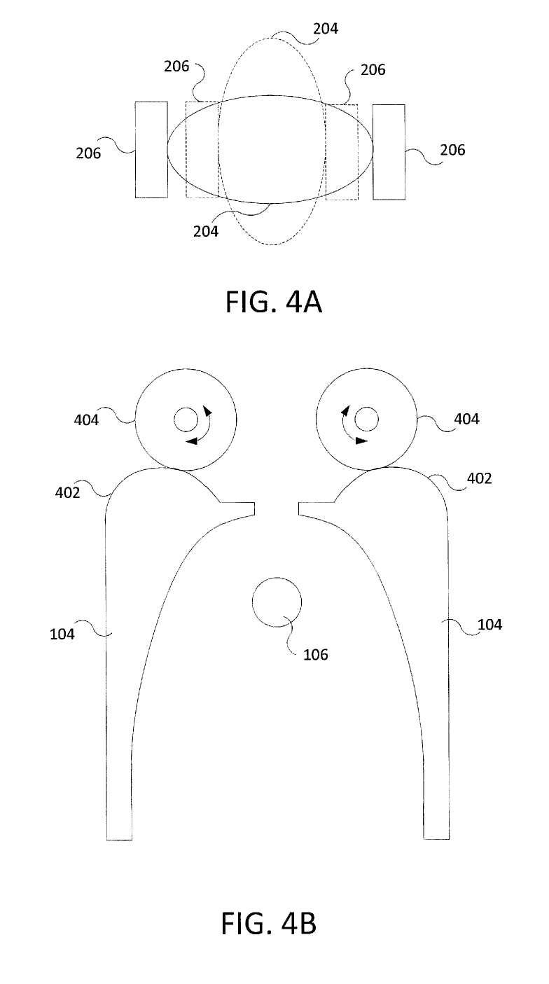

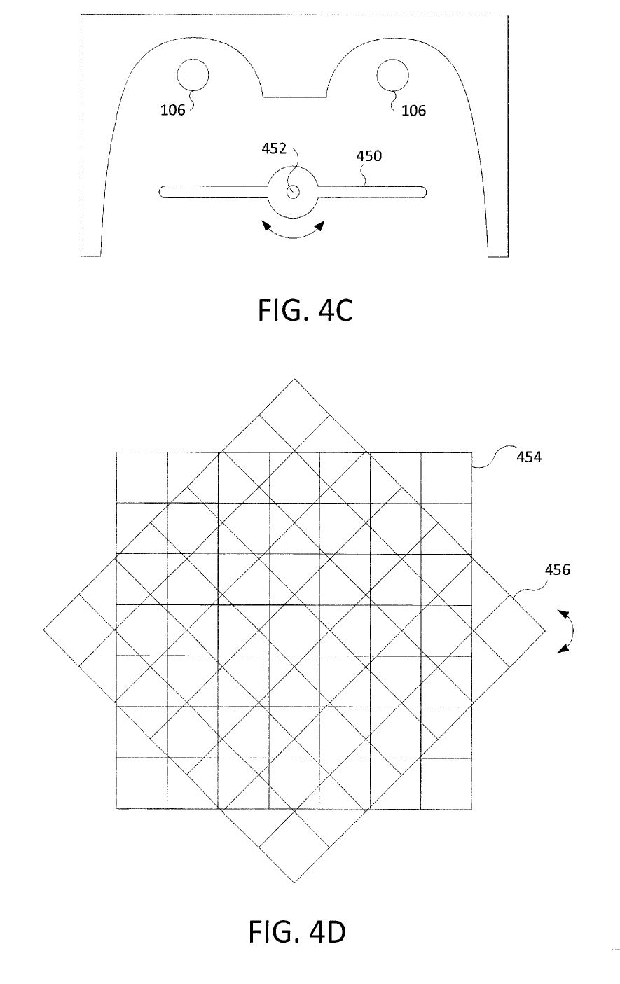

FIGS. 4A-4D illustrate different examples of coupling mechanism and shutter designs that can be used. FIG. 4A illustrates a top view of the cam 204 that has an elliptical shape as described above. As shown by the dashed lines, as the cam 204 is rotated by the servo motor 202, the cam 204 pushes the extending members 206 apart with the widest portion of the cam 204 and the extending members 206 are moved closer together with the narrowest portion of the cam 204.

FIG. 4B illustrates a cross sectional view of another coupling mechanism that uses circular cams 404. In some examples, the shutters 104 may have a rounded or circular top portion 402 that is in contact with the circular cams 404. The servo motor 202 may be coupled to the circular cams 404 and used to rotate the circular cams 404 clockwise and counterclockwise to move the shutter 104 into a full open position, a full closed position, and any position in between.

FIG. 4C illustrates a cross sectional view of an alternate shutter design that uses rotating blind shutter 450. For example, the rotating blind shutter 450 may rotate around a pivot point 452 to control the energy output between two adjacent light sources 106. The pivot point 452 may be coupled using one of the coupling mechanisms described above with a servo motor 202.

FIG. 4D illustrates a bottom view of another alternate shutter design that uses a moiré grid. For example, a first moiré grid shutter 454 may be coupled to a rotating second moiré grid shutter 456. In one example, the shutters 454 and 456 may be fully open when the first moiré grid shutter 454 and the second moiré grid shutter 456 are aligned. The shutters 454 and 456 may be fully closed when the second moiré grid shutter 456 is rotated 45 degrees over the first moiré grid shutter 454 as shown in FIG. 4D. In another example (not shown), the shutters 454 and 456 may be fully closed when the second moiré grid shutter 456 is moved linearly over the first moiré grid shutter 454 such that the grids intersect one another. In some examples, the size of the openings and the size of each line of the grid may be selected to ensure that each line covers the opening when the second moiré grid shutter 456 is rotated 45 degrees, or linearly moved, over the first moiré grid shutter 454.

In one implementation, each shutter 104 may be coupled to a separate servo motor 202. In another example, a single servo motor 202 may be used with a gear mechanism connected to each cam 204 or circular cam 404 of each shutter 104. For example, the servo motor 202 and the cams 204 or circular cams 404 may be coupled via a sliding system, a worm gear drive, and the like.

In another example, the plurality of shutters 104 may be divided into different zones along a length of the energy source 106. A servo motor 202 may be used to control a cam 204 coupled to each shutter 104 within a zone. In one example, each zone may be based on a size and length of the energy source 106 and the apparatus 100. Each zone may have any number of servo motors 202 and any number of shutters 104 per zone. For example, if the energy source is divided into four zones that each include five shutters 104, then a single servo motor 202 may be used to control five cams 204 on each of the five shutters 104 for each one of the four zones (e.g., four servo motors controlling a total of 20 shutters would be used for four zones of energy sources).

As a result, the shutters 104 may provide more control over an amount of energy or heat applied to a particular coordinate of the powder bed 112. In one example, a coordinate of the powder bed may be defined by a position of the movable carriage 102 in a first direction and a location of a shutter 104 along a length of the energy source 106 in a second direction. In addition, the shutters 104 may be controlled to operate with a higher frequency than turning the energy source 106 on and off, or dimming the energy source between on and off.

In addition, it should be noted that although the reflective inner sides 210 and the shutter 104 are combined the reflective inner sides 210 and the shutter 104 may be separated as separated structures. For example, the reflective inner sides 210 may be deployed as a fixed reflector and the shutter 104 may be deployed as a separate structure below the fixed reflector. Other arrangements and combinations of the reflective inner sides 210 and the shutter 104 may be within the scope of the present disclosure.

It should be noted that the apparatus 100 has been simplified for ease of explanation. For example, the apparatus 100 may include other components, such as, a housing encasing the entire apparatus 100, a print chamber, a powder supply, a fluid supply, a platen lift, and the like.

Although the movable carriage 102 is described above with respect to a 3D printing application, it should be noted that the movable carriage 102 having the plurality of shutters 104 may also be used for other applications. For example, the movable carriage 102 with the plurality of shutters 104 may be used in any application that uses curing, fusing or melting (e.g., an ultra violet (UV) curable 3D printer, curable inks on a sheet of paper, and the like).

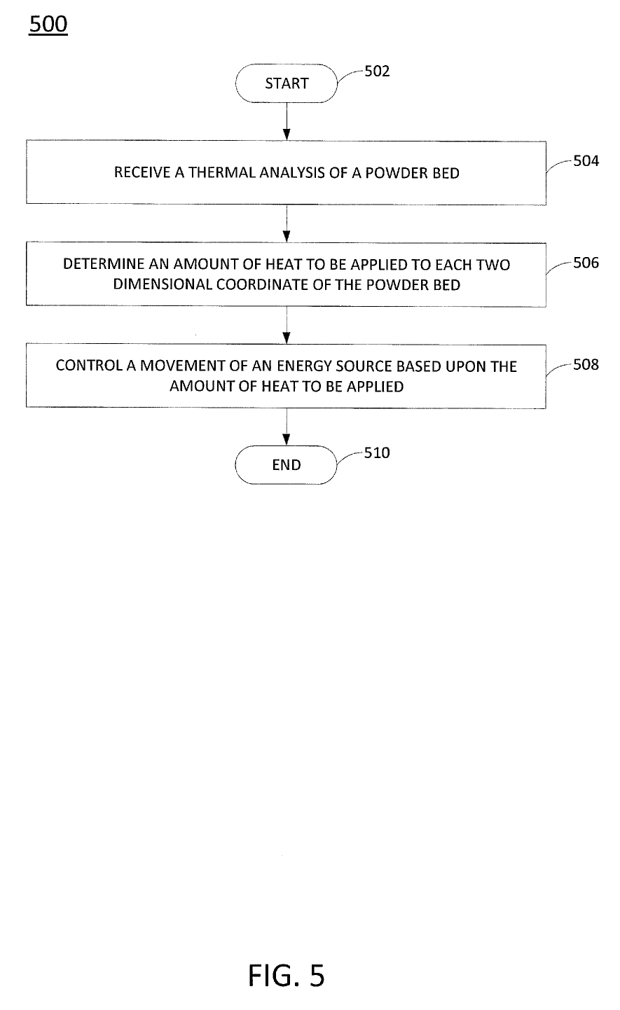

FIG. 5 illustrates an example flowchart of a method 500 for controlling the movable carriage having an energy source and a plurality of shutters. In one example, the method 500 may be performed by the controller 110. In some examples, the example sequence of operations illustrated in the example flowchart of FIG. 5 may be implemented as executable instructions stored in a non-transitory machine-readable storage medium.

At block 502 the method 500 begins. At block 504, the method 500 receives a thermal analysis of a powder bed. For example, a thermal camera may take a thermal image or perform a thermal scan of a powder bed. Based on the thermal image or the thermal scan, the necessary amount of heat may be applied to the appropriate areas on the powder bed.

At block 506, the method 500 determines an amount of heat to be applied to each two dimensional coordinate of the powder bed. For example, on a first pass the entire bed may be the same temperature. However, after the first pass different portions of the powder bed may have been heated. Thus, applying the same amount of heat to particular areas may cause too much heat to be applied to the particular areas. Excessive heat may disperse to adjacent areas causing other areas that should not be heated to be heated. This can affect the overall finished item created by the 3D printer.

In one example, each two dimensional coordinate may be defined by a position of the movable carriage in a first direction and a location of a shutter along a length of the energy source. For example, the movable carriage may have 20 shutters along a length of the movable carriage. Each coordinate may be represented by a position of the movable carriage along a scan direction and one of the 20 shutters along the length of the movable carriage in a grid system.

The amount of heat to be applied may also be a function of controlling how much energy is released by the energy source. For example, the energy source may be turned on, turned off or dimmed to any level of energy output between on and off.

At block 508, the method 500 controls a movement of an energy source based upon the amount of heat to be applied. For example, the movement of the energy source may be controlled in a first axis (e.g., the scan direction) and a position of each one of the plurality of shutters along a length of the energy source in a second axis to apply the amount of heat to each two dimensional coordinate of the powder bed based upon the determining block 506.

In addition, the number of passes made per layer may be controlled. For example, the formation of each layer of a particular item may receive multiple passes of the movable carriage.

In some examples, controlling the movement of the energy source may also include controlling a speed of the movable carriage in the scan direction. In one example, controlling each one of the plurality of shutters may include controlling an amount each shutter is opened at each position of the movable carriage or a rate or frequency of opening/closing of each one of the plurality of shutters (e.g., for modulating the energy source). In one example, the opening may be controlled to be fully open, fully closed, or any position in between. In other words, the shutters may be opened between 100% to 0%, or any percentage in between.

In one implementations, the blocks 504, 506 and 508 may be repeated for each layer of a particular item that is built in a 3D printer. For example, if 100 layers are used to build a particular item in a 3D printer, the blocks 504, 506 and 508 may be repeated for each layer for a total of 100 loops through the blocks 504, 506 and 508. At block 510, the method 500 ends.

It should be noted that although not explicitly specified, any of the blocks, functions, or operations of the example method 500 described above may include a storing, displaying, and/or outputting block as used for a particular application. In other words, any data, records, fields, and/or intermediate results discussed in the methods can be stored, displayed, and/or outputted to another device as used for a particular application.

It will be appreciated that variants of the above-disclosed and other features and functions, or alternatives thereof, may be combined into many other different systems or applications. Various presently unforeseen or unanticipated alternatives, modifications, or variations, therein may be subsequently made which are also intended to be encompassed by the following claims.

1. An apparatus, comprising:
a movable carriage;
an energy source coupled to the movable carriage; and
a plurality of shutters coupled to the movable carriage along a length of the energy source, wherein each one of the plurality of shutters is coupled to the movable carriage via a respective coupling mechanism that provides a continuously variable movement of each one of the plurality of shutters.

2. The apparatus of claim 1, wherein the movable carriage moves the energy source in a scan direction.

3. The apparatus of claim 1, wherein an inner surface of each one of the plurality of shutters comprises a reflective material.

4. The apparatus of claim 1, wherein the each one of the plurality of shutters comprises a pair of opposing shutter members.

5. The apparatus of claim 1, wherein the each one of the plurality of shutters comprises a single shutter having a conic cross-section.

6. The apparatus of claim 1, wherein the respective coupling mechanism for the each one of plurality of shutters comprises a servo motor coupled to at least one of: an elliptical cam or a circular cam.

7. The apparatus of claim 1, wherein two or more of the plurality of shutters has a different opening width for an open position.

8. A method, comprising:
receiving, by a processor, a thermal analysis of a powder bed;
determining, by the processor, an amount of heat to be applied to each two dimensional coordinate of the powder bed; and
controlling, by the processor, a movement of an energy source and a position of each one of a plurality of shutters along a length of the energy source to apply the amount of heat to the each two dimensional coordinate of the powder bed based upon the determining.

9. The method of claim 8, wherein the receiving, the determining and the controlling are repeated for each pass over the powder bed.

10. The method of claim 8, wherein the position of the each one of the plurality of shutters comprises opening the each one of the plurality of shutters between 0% to 100%.

11. The method of claim 10, wherein two or more of the plurality of shutters has a different opening width when open to 100%.

12. An apparatus, comprising:
a powder bed;
a thermal camera positioned over the powder bed to measure an amount of heat at each coordinate of the powder bed;
a movable carriage comprising an energy source and a plurality of shutters along a length of the energy source, wherein each one of the plurality of shutters is coupled to the heat carriage via a respective coupling mechanism that provides a continuously variable movement of each one of the plurality of shutters; and
a controller coupled to the thermal camera and the movable carriage, wherein the controller is for controlling the movement of the heat carriage and the each one of the plurality of shutters based upon the amount of heat measured by the thermal camera at the each coordinate of the powder bed.

13. The apparatus of claim 12, wherein the controlling the movement comprises controlling a speed of the movable carriage along a length of the powder bed.

14. The apparatus of claim 12, wherein the controller sends a control signal to the respective coupling mechanism of the each one of the plurality of shutters to open the each one of the plurality of shutters between 0% to 100%.

15. The apparatus of claim 12, wherein the energy source comprises a halogen lamp.
